(19) United States
(12) Patent Application Publication
(10) Pub. No.: US 2011/0042981 A1
(43) Pub. Date: Feb. 24, 2011

(54) MATERIAL HANDLING TOOL

(76) Inventor: Timothy M. Coutu, Edmonton (CA)

Correspondence Address: QUICKPATENTS, INC., 32861 CALLE PERFECTO, SUITE A, SAN JUAN CAPISTRANO, CA, 92675, US

(21) Appl. No.: 12/545,842

(22) Filed: Aug. 23, 2009

(51) Int. Cl. A01B 1/20; A01B 1/02

(52) U.S. Cl. 294/51

(57) ABSTRACT

The present device is a tool for manipulating a material, such as snow or ice, resting on a surface. The tool includes an elongated handle, an elongated shaft, and a compound blade. The handle is attached to a proximal end of the elongated shaft and the compound blade is fixed to a distal end of the elongated shaft. The compound blade has a first blade section adapted for shoveling the material and a second blade section adapted for chopping, pushing, and pulling the material. The longitudinal axes of the distal and proximal ends of the elongated shaft are parallel but distally offset, making the tool more ergonomic and effective in use, with either a continuous or discontinuous contour along the elongated shaft. The tool may also be used in a variety of angles and orientations.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to snow shovels, and more particularly to combination snow shovels.

### DISCUSSION OF RELATED ART

Combination snow shovels are well known in the art. For example, U.S. Pat. No. 1,260,276 to W. H. Miller on Mar. 19, 1918 teaches such a device. Such devices are made to move snow and ice to a desired location. However, despite the development of many approaches to combination snow shovels, these approaches often have significant drawbacks.

U.S. Pat. No. 3,222,699 to L. L. Zeisig on Dec. 14, 1965 teaches a snow shovel with handle mounted ice chopper. The Zeisig device is effective as a shovel and ice chopper. However, the Zeisig device has the disadvantage that the ice chopper is located on the handle of the shovel and the device must be completely inverted to use. In use, the handle will be become wet and dirty and is not an ideal combination of the two devices. Furthermore, the Zeisig device takes time to invert and requires two different techniques of holding the handle. Therefore, a device is needed that does not need to be inverted end-to-end to be used. Furthermore, the needed device would be able to quickly and easily change from the shoveling position to the ice breaking position. Also, the needed device would provide a comfortable and ergonomic angle of the handle in use.

U.S. Pat. No. 1,260,276 to W. H. Miller on Mar. 19, 1918 also teaches a snow shovel and ice chopper. The Miller device teaches attaching an ice chopping blade on the end of the shovel. This approach avoids the problem of having to invert the tool end-to-end and keeps the handle from becoming wet and dirty. However, this approach has the drawback of using a separate attachment that needs to be added and removed depending on needs of the user. Also, the ice chopper attachment is designed to be used in a mostly vertical up-and-down motion transferring the impact of breaking the ice primarily vertically up the handle of the tool. Therefore, there is a need for a device that does not need a separate attachment for each function. Furthermore, a device is needed where the structure of the ice chopper function avoids direct transfer of impact up the handle and limits the impact of repetitive motion of breaking ice.

A couple devices teach combination snow shovels that are made of one-piece and do not need attachments. US Patent Application 2006/0197349 by Dawes published on Sep. 7, 2006 teaches a combination snow shovel and snow plow. US Patent Application 2009/0051180 A1 by Marlin published on Feb. 26, 2009 teaches a snow removal tool for the pushing and pulling of snow. However, neither one of these devices provides the ability to chop ice. They are suitable for their designed function of pushing and pulling snow, but they are not sturdy enough and do not disclose a structure to break up ice. Therefore, there is a need for a device that not only provides the functions of shoveling, pushing, and pulling snow, but further includes the structure and sturdiness to withstand the forces of chopping ice.

Therefore, there is a need for a device that does not require being inverted end-to-end to be used. Furthermore, the needed device would be able to quickly and easily change from the shoveling position to the ice breaking position. Also, the needed device would provide a comfortable and ergonomic angle of the handle in use. There is a need for a device that does not need a separate attachment for each function. Clearly there is a need for a device where the structure of the ice chopper or scraper feature avoids direct transfer of impact up the handle and limits the impact to the user of repetitive motion of breaking ice. Further, the needed device would provide the functions of shoveling, pushing, and pulling snow, and include the structure to chop ice and the sturdiness to withstand the forces of repeated ice chopping. The present invention accomplishes these objectives.

### SUMMARY OF THE INVENTION

The present device is a tool for manipulating a material resting on a surface. The tool includes an elongated handle having proximal and distal ends. An elongated shaft has a means for attaching to the handle at a proximal end thereof.

A compound blade is fixed at a center portion thereof to a distal end of the elongated shaft. The compound blade has a first blade section adapted for shoveling the material when the first blade section is used at an angle of less than approximately 30 degrees with respect to the surface. The compound blade has a second blade section adapted for chopping or scraping the material when the second blade section is used at an angle of more than approximately 60 degrees with respect to the surface.

The tool may be used to both alternately shovel and chop or scrape the material. The handle is kept at generally the same angle with respect to the surface but rotated to alternately allow either the first or second blade sections to be used on the material. In another embodiment, the second blade section is adapted for chopping the material when the second blade section is used at an angle of more than approximately 60 degrees but less than 90 degrees, with respect to the surface.

In another embodiment, the longitudinal axes of the distal and proximal ends of the elongated shaft are parallel but distally offset. In another embodiment, the offset of the distal and proximal ends is formed by a continuous contour along the elongated shaft. In another embodiment, the offset of the distal and proximal ends is formed by at least two substantially discontinuous contours along the elongated shaft. In another embodiment, each first and second blade section includes a continuous contour along its length.

The present invention is a tool that does not require being inverted end-to-end to be used. Furthermore, the needed device may be quickly and easily rotated from the shoveling position to the ice breaking position. Also, the needed device provides a comfortable and ergonomic angle of the handle in use. The device does not need a separate attachment for each function. Additionally, the structure of the ice chopper or scraper feature avoids direct transfer of impact up the handle and limits the impact to the user of repetitive motion of breaking ice. Further, the tool provides the functions of shoveling, pushing, and pulling snow, and includes the structure to chop ice and the sturdiness to withstand the forces of repeated ice chopping. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of the invention, illustrating a tool manipulating a material on a surface;

FIG. 2 is a side elevational view of the invention in a chopping position, illustrating a continuous contour along an elongated shaft;

FIG. 3 is a partially exploded perspective view of the invention, illustrating a pin, an elongated shaft, an elongated handle, and a compound blade;

FIG. 4 is a side elevational view of the invention in a shoveling position, illustrating a continuous contour along an elongated shaft; and

FIG. 5 is a partially exploded side elevational view of the tool, illustrating cooperating screw threads on an elongated handle and shaft, and illustrating discontinuous contours along an elongated shaft.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

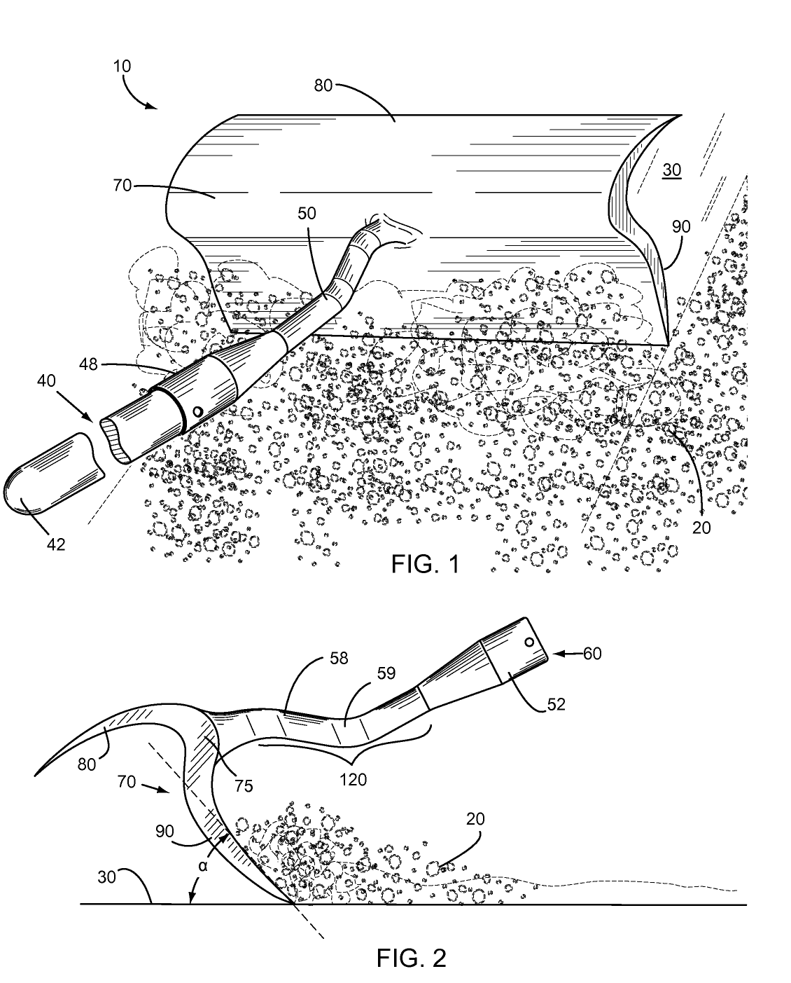

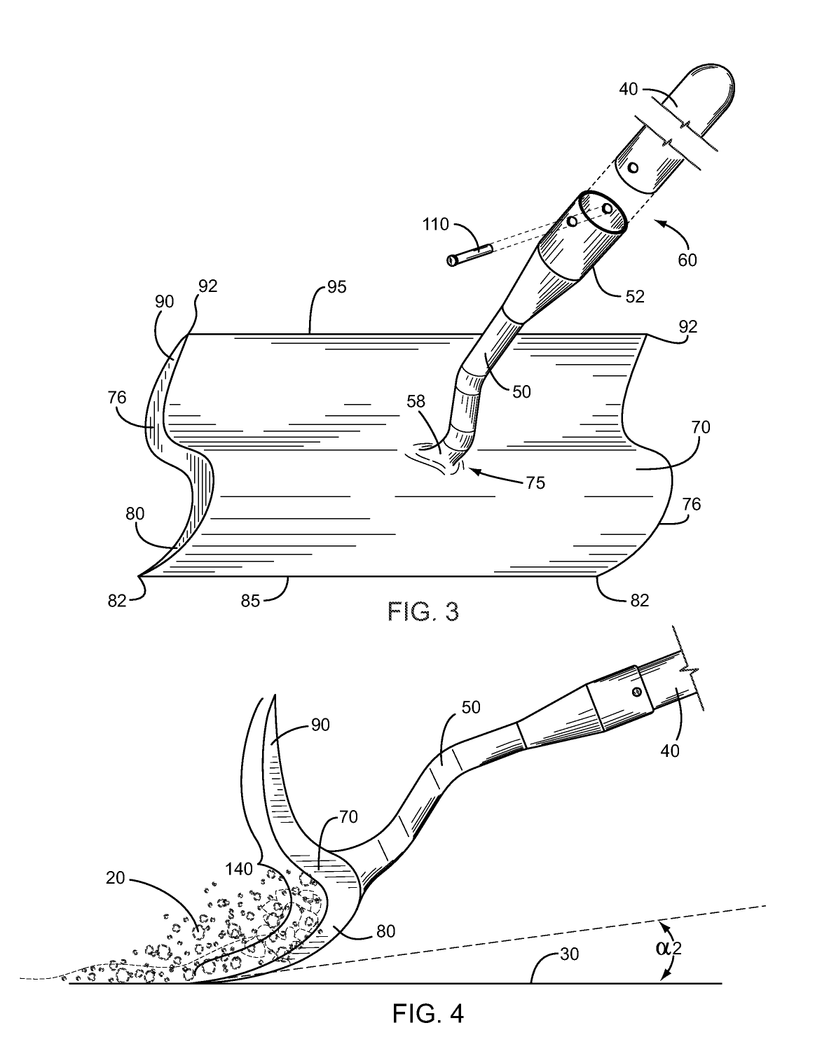

With respect to the drawings, FIG. 1 illustrates a tool 10 for manipulating a material 20 resting on a surface 30. The material 20 can be a variety of materials, such as snow, ice, slush, sand, salt, dirt, gravel, concrete, grains, and the like; though the tool 10 is primarily focused towards the needs of manipulating ice and snow. The tool 10 includes an elongated handle 40 having proximal 42 and distal ends 48, as illustrated in FIG. 1. In FIG. 3, an elongated shaft 50 has a means for attaching 60 to the handle 40 at a proximal end 52 thereof.

In FIG. 2, a compound blade 70 is fixed at a center portion 75 thereof to a distal end 58 of the elongated shaft 50. The compound blade 70 has a first blade section 80 adapted for shoveling the material 20 when the first blade section 80 is used at an angle α₁ of less than approximately 30 degrees with respect to the surface 30, as illustrated in FIG. 4. The compound blade 70 has a second blade section 90 adapted for chopping or scraping the material 20 when the second blade section 90 is used at an angle α₂ of more than approximately 60 degrees with respect to the surface 30, as illustrated in FIG. 2. At the angle α₂, the second blade section 90 is also adapted for pushing and pulling material 20 along the surface 30. Herein, the term “chopping” may also refer to scraping.

The tool 10 may be used to both alternately shovel and chop the material 20. The handle 40 is kept at generally the same angle with respect to the surface 30 but rotated to alternately allow either the first or second blade sections 80,90 to be used on the material 30. In another embodiment, the second blade section 90 is adapted for chopping or scraping the material 20 when the second blade section 90 is used at an angle of more than approximately 60, degrees but less than 90 degrees, with respect to the surface 30, as illustrated in FIG. 2.

Each first and second blade section 80,90 ends in an ending edge 85,95 9 (FIG. 2). In a preferred embodiment, each ending edge 85,95 is substantially parallel to each other. In another embodiment, each blade section 80,90 is preferably sharpened along each ending edge 85,95 to achieve optimal results, as illustrated in FIGS. 2 and 3. Sharpness contributes to separating compact snow and ice from surfaces without the need to thrust excessively downward which may cause damage to the surface 30 and/or pain and injury to the user.

The tool 10 may also be used in additional orientations. In a diagonal orientation (not shown), the corners 82, 92 (FIG. 3) of the compound blade 70 may be used at various angles to the surface to reach into narrow crevices of the surface 30. In a sideways orientation, the side edges 76 may be used to manipulate material 20 near trees and poles and around other structures (not shown) on the surface 30. In one embodiment, each side edge 76 of the compound blade 70 is planar, providing the ability to manipulate the material 20 on the surface 30. In another embodiment, each planar side edge 76 is substantially orthogonal to each ending edge 85,95.

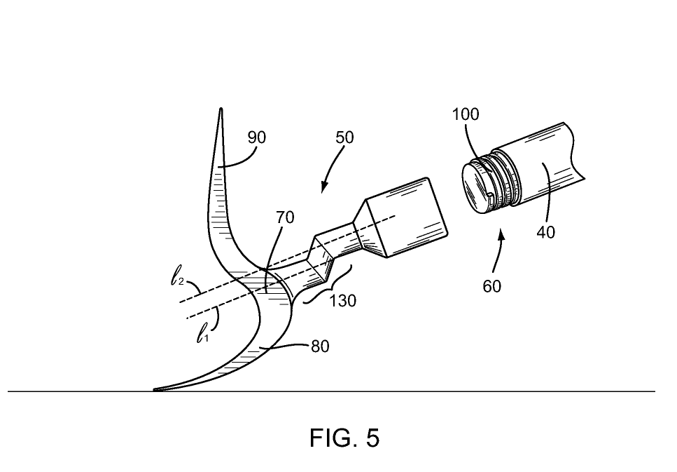

In another embodiment, illustrated in FIG. 5, the means for attaching 60 the elongated shaft 50 to the handle 40 includes cooperating screw threads 100 on the elongated shaft 50 and the handle 40. In another embodiment, illustrated in FIGS. 3 and 4, the means for attaching 60 the elongated shaft 50 to the handle 40 includes a pin 110 traversing the elongated shaft 50 and handle 60 when mutually attached. The pin 110 secures the handle 40 to the elongated shaft 50.

As illustrated in FIG. 5, the longitudinal axes of the distal l₁ and proximal ends l₂ of the elongated shaft 50 are parallel but distally offset, which provides a more ergonomic and efficient angle when using the tool 10. In one embodiment, the offset of the distal l₁ and proximal ends l₂ is formed by a continuous contour 120 (FIG. 2) along the elongated shaft 50. In another embodiment, the offset of the distal l₁ and proximal ends l₂ is formed by at least two substantially discontinuous contours 130 (FIG. 5) along the elongated shaft 50.

In another embodiment, each first and second blade section 80, 90 includes a continuous contour 140 (FIG. 4) along its length.

In one embodiment, the compound blade 70 may be formed from a single metal casting process. In another embodiment, the compound blade 70 may be formed from an extrusion process. In these embodiments, the elongated shaft 50 may be fixed to the compound blade 70 using mechanical fasteners or welding. In one more embodiment, the compound blade 70 and elongated shaft 50 may be formed from a single metal casting process. The tool 10 is preferably made from a strong and durable material such as a rigid metal material, but can also be formed from any suitable durable rigid material, such as a hard rigid plastic material, if desired. The elongated handle 40 may also be made from a rigid durable material such as wood or fiberglass.

The size of the tool 10 may be adjusted for different sized users and working needs. An advantage of the tool 10 is that it can be a size that is efficient for removing material 20 such as snow, slush and ice from steps (not shown). Some steps are not very deep and the structure of each blade section 80,90 is of a design well suited to be able to effectively remove material 20 from steps. Another advantage is that the tool 10 combines several functions together which can each be used in an ergonomic manner. When the weather is cold and unpleasant, having one device with many features avoids the hassle and inconvenience of carrying multiple devices or going back and forth to retrieve additional devices.

While a particular form of the invention has been illustrated and described, it will be apparent that various modifications can be made without departing from the spirit and scope of the invention. For example, the means for attaching 60 the elongated shaft 50 to the handle 40 may include gluing, welding, or additional mechanical fasteners. Accordingly, it is not intended that the invention be limited, except as by the appended claims.

The teachings provided herein can be applied to other systems, not necessarily the system described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the system may vary considerably in its implementation details, while still being encompassed by the invention disclosed herein.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventor contemplates the various aspects of the invention in any number of claim forms.

Accordingly, the inventor reserves the right to add additional claims after filing the application to pursue such additional claim forms for other aspects of the invention.

What is claimed is:

1. A tool for manipulating a material resting on a surface, the tool comprising:
an elongated handle having proximal and distal ends;
an elongated shaft having a means for attaching to the handle at a proximal end thereof, and
a compound blade fixed at a center portion thereof to a distal end of the elongated shaft, the compound blade having a first blade section adapted for shoveling the material when the first blade section is used at an angle of less than approximately 30 degrees with respect to the surface, and having a second blade section adapted for chopping the material when the second blade section is used at an angle of more than approximately 60 degrees with respect to the surface;
whereby the tool may be used to both alternately shovel and chop the material, the handle being kept at generally the same angle with respect to the surface but rotated to alternately allow either the first or second blade sections to be used on the material.

2. The tool of claim 1 wherein the second blade section is adapted for chopping the material when the second blade section is used at an angle of more than approximately 60, degrees but less than 90 degrees, with respect to the surface.

3. The tool of claim 1 wherein the means for attaching the elongated shaft to the handle includes cooperating screw threads on the elongated shaft and the handle.

4. The tool of claim 1 wherein the means for attaching the elongated shaft to the handle includes a pin traversing the elongated shaft and handle when mutually attached, the pin securing the handle to the elongated shaft.

5. The tool of claim 1 wherein the longitudinal axes of the distal and proximal ends of the elongated shaft are parallel but distally offset.

6. The tool of claim 5 wherein the offset of the distal and proximal ends is formed by a continuous contour along the elongated shaft.

7. The tool of claim 5 wherein the offset of the distal and proximal ends is formed by at least two substantially discontinuous contours along the elongated shaft.

8. The tool of claim 1 wherein each first and second blade section includes a continuous contour along its length.

9. The tool of claim 1 wherein the compound blade is formed from a single metal casting process.

10. The tool of claim 1 wherein the compound blade is formed from an extrusion process.

11. The tool of claim 1 wherein each first and second blade section ends in an ending edge and each ending edge is substantially mutually parallel.

12. The tool of claim 11 wherein each side edge of the compound blade is substantially planar.

13. The tool of claim 12 wherein each side edge is substantially orthogonal to each ending edge.
